(19) United States
(12) Patent Application Publication
(10) Pub. No.: US 2020/0353413 A1
(43) Pub. Date: Nov. 12, 2020

(54) METHODS AND SYSTEMS FOR SPATIALLY SEPARATING OR DISTRIBUTING ISOTOPES

(71) Applicant: Millikelvin Technologies LLC, Braintree, MA (US)

(72) Inventor: Neal Kalechofsky, Stow, MA (US)

(21) Appl. No.: 16/834,692

(22) Filed: Mar. 30, 2020

Related U.S. Application Data
(63) Continuation of application No. PCT/US2018/053804, filed on Oct. 1, 2018.
(60) Provisional application No. 62/565,481, filed on Sep. 29, 2017.

(51) Int. Cl. B01D 59/00; C01B 32/50; H01F 1/00

(52) U.S. Cl. CPC B01D 59/00; H01F 1/0045; H01F 1/0009; C01B 32/50

(57) ABSTRACT

Methods and related systems for separating isotopes of an element are provided. The element has at least two isotopic forms. The method includes hyperpolarizing one or more of the isotopic forms in a feedstock, and applying a magnetic field to the target isotopes in order to at least partially spatially separate the isotopic forms of the element from one another.

### CROSS-REFERENCE TO RELATED APPLICATIONS

This patent application is a continuation of International Application No. PCT/US2018/053804, filed on Oct. 1, 2018, which in turn claims the benefit of priority to U.S. Provisional Patent Application Ser. No. 62/565,481, filed Sep. 29, 2017. This patent application is related to U.S. Pat. Nos. 6,651,459, 8,703,201 and 8,703,102. The disclosure of each of the foregoing patents and patent application are incorporated by reference herein in its entirety for any purpose whatsoever.

### SUMMARY OF THE DISCLOSURE

The purpose and advantages of the present disclosure will be set forth in and become apparent from the description that follows. Additional advantages of the disclosure will be realized and attained by the methods and systems particularly pointed out in the written description and claims hereof, as well as from the appended drawings.

To achieve these and other advantages and in accordance with a first aspect of the disclosure, methods and systems for separating isotopes of a given element are disclosed. A first illustrative method includes:
1) hyperpolarizing a quantity of a provided element, wherein the element includes at least two isotopes with differing nuclear magnetic moments and/or differing nuclear magnetic moment relaxation rates.
2) applying a magnetic field (such as in the form of a magnetic field gradient), to produce spatial separation between the isotopes such that the concentration of a given isotope in a given region of space is different than it was prior to application of the field.
3) repeating the first two steps recited above as desired in order to produce a desired level of enrichment in the concentration of a desired isotope in a given region of space.

In accordance with some implementations, the isotope to be separated is ¹³C being separated from ¹²C, to facilitate production of molecules having an enriched content of ¹³C. In accordance with some implementations, the ¹²C and ¹³C atoms are contained in the molecule carbon dioxide (CO₂). In some implementations, the percentage of ¹³C/¹²C in the CO₂ is ˜1.1% which is the naturally occurring ratio of ¹³C to ¹²C.

In some implementations, the ¹³C enriched ¹³CO₂ can be converted into other molecules, such as (but not limited to) 1-¹³C urea and 1-¹³C pyruvate, using chemistry techniques known in the art for producing those molecules generally.

Molecules enriched in ¹³C atoms are used in a variety of applications. In particular, 1-¹³C urea is used in clinical diagnosis of H. Pylori bacteria which is a cause of ulcers and some gastric cancers. In addition, 1-¹³C pyruvate is increasingly in demand as part of magnetic resonant imaging scans to diagnose prostate cancer, heart disease and other metabolic disorders. Other molecules, such as ¹³C enriched glucose, are widely employed in biochemical research and pharmaceutical drug development.

The naturally occurring percentage of ¹³C in carbonated molecules is ˜1.1%. The applications described above typically require molecules where the percentage of ¹³C is 99%. Isotopically enriched molecules are therefore highly valuable and typically sell for orders of magnitude more in dollars per gram than the same molecule that is not isotopically enriched.

A variety of separation methods are described in the art for isotopically enriching carbonated molecule to contain ˜99% ¹³C rather than the naturally occurring 1.1% ¹³C. These include vapor diffusion, fractional distillation, centrifuge, and atomic vapor laser isotope separation (AVLIS). The first three exploit the atomic mass difference between ¹²C and ¹³C to produce isotopically enriched ¹³C molecules. AVLIS works by preferentially ionizing molecules containing a given isotope and then using electromagnetic force to produce isotopic separation.

Isotopic enrichment methods are generally characterized by a separation factor ε. Methods that rely on mass differences to separate isotopes generally have smaller ε but higher throughput rates. AVLIS can have very high ε but throughput rates are generally very small, and inadequate to commercial needs such as those described above. The present disclosure addresses these issues by making possible both high ε and high production rates that can address the growing market for isotopically enriched materials, ¹³C enriched molecules in particular.

The most common separation technique employed for manufacturing enriched ¹³C molecules is to use fractional distillation (FD) of carbon monoxide (CO). In this approach, CO is liquefied by cooling it to approximately 68 K. The percentage of ¹³CO in the gaseous phase is slightly different than in the liquid phase (˜0.008) leading to slight enrichment of ¹³CO in the liquid phase. Thus by separately collecting the liquid and vapor phases, over many repeat steps the ¹³CO in the liquid phase can be greatly enhanced. The separation factor ε for an ideal FD process for CO at 68 K is 1.012. As a result, production of 99% enriched CO is a laborious and expensive process requiring many separation stages. To maximize throughput, this is typically done in long (˜500 foot) columns where separation can be conducted in a continuous fashion. FD columns cost ˜$8-$10M each to build and produce ˜1-2 kg of 99% ¹³CO per week.

The FD process described above typically uses carbon monoxide (CO), and less typically methane (CH₄), as its feedstock. CO and CH₄ are environmentally problematic, as they are both flammable and toxic. They are also much more expensive per gram than CO₂. To Applicant's knowledge, at time of this writing there are no FD columns that use CO₂ as a feedstock. This is because CO₂ is not a liquid under standard pressures and producing a column of liquid CO₂ may require maintaining a pressure head of at least 5 bar. In a 500 foot FD column this would be extremely challenging. Embodiments set forth herein can be used equally for both CO and CO₂ as feedstock, with feedstock CO₂ as a preferred embodiment due to the factors described above.

Thus, in some implementations, a method of separating isotopes of an element is provided, the element having at least two isotopic forms. The method includes hyperpolarizing one or more of said isotopic forms in a feedstock, and applying a magnetic field to the target isotopes in order to at least partially spatially separate the isotopic forms of the element from one another.

If desired, hyperpolarization can be produced by cooling the isotopic forms in the presence of a magnetic field. The isotopic forms can be cooled to at or below about 10 K in temperature and the magnetic field is at or above about 1 Tesla. An adulterant can be added to the frozen element to hasten T1 in a brute force environment. If desired, a quantum relaxation switch (“QRS”) can be used to hasten hyperpolarization of target isotope. At least one isotope of the element can have a non-zero nuclear spin. Any of the techniques described in the patents incorporated by reference herein can be used to perform the hyperpolarization.

If desired, the element can be carbon. For example, the element can be carbon in the form of carbon dioxide, carbon monoxide, or methane, among others. Separation of isotopic forms can take place in a liquid state, a gaseous state, and/or a boundary between the liquid and gaseous states.

In some implementations, a magnetic field gradient can be used to facilitate the separation step. For example, the magnetic field gradient can be pulsed in time. If desired, the percentage of ¹³CO₂ in the feedstock CO₂ can be <1%. If desired, the percentage of ¹³CO₂ in the feedstock CO₂ can be <10%, <20%, <30%, <40%, <50%, <60%, <70%, <80%, <90% or <100%. If desired, differing nuclear polarization levels in an ensemble of more than one target isotope can be produced by waiting a specified period of time for the nuclear polarization of one isotope to decay away to a smaller value than that of the other isotope or isotopes.

It will be understood that both the foregoing general description and the following detailed description are exemplary and are intended to provide further explanation of the disclosed embodiments. The accompanying drawings, which are incorporated in and constitutes part of this specification, is included to illustrate and provide a further understanding of the methods and systems of the disclosure. Together with the description, the drawings serve to explain the principles of the disclosed embodiments.

### BRIEF DESCRIPTION OF THE DRAWINGS

FIG. 1 is a chart illustrating a brute force (high B/T) polarization of ¹³C.

FIG. 2 illustrates the spatial separation of ¹³CO₂ from ¹²CO₂ produced by polarized ¹³CO₂ molecules attracted towards field center of an ambient magnet (not shown).

### DETAILED DESCRIPTION OF THE PREFERRED EMBODIMENT

Reference will now be made in detail to the present preferred embodiments of the disclosure. The method and corresponding steps of the disclosure will be described in conjunction with the detailed description of the system.

Materials containing non-zero nuclear magnetic moments have, in an external magnetic field, at least two energy states. These states are characterized in the art as “up” or “down” in reference to the direction of the external magnetic field vector, and the polarization P is defined as:

P=Nᵤₚ−N_{down}/N

where N=Nᵤₚ+N_{down}. Nuclear polarization is a function of ambient temperature T and magnetic field B under the equation P=tan h(γB/kT) where γ is the nuclear gyromagnetic ratio and k is Boltzmann's constant. Under ordinary equilibrium circumstances of T˜300 K and B<<1 T the nuclear polarization of ensemble of ¹³C atoms is very small, less than a few parts per million.

“Hyperpolarization” refers to one or more techniques whereby the nuclear magnetic polarization P is temporarily enhanced, often by many orders of magnitude, above equilibrium. Techniques that are known in the art include laser polarization, dynamic nuclear polarization (DNP), Parahydrogen Induced Polarization (PHIP), and Brute Force (BF). Note that in the description that follows, any of the hyperpolarization techniques currently known in the art can be used to produce isotopic separation, with brute force being one particularly preferred embodiment.

Because the hyperpolarized state is by definition out of equilibrium, there is always a characteristic relaxation time wherein the system relaxes back to thermal equilibrium. In the art this time is known as T1. T1 can differ because of many factors including chemical composition, temperature, external magnetic field, etc. Generally polarization varies with time as P˜exp (−t/T1).

In addition to having different masses, isotopes often have different nuclear magnetic moments and/or different T1s. As a particular non exclusive example, the rare and valuable isotope of carbon ¹³C has a nuclear spin of ½, while the most common isotope of carbon ¹²C has a nuclear spin of 0.

Nuclei with non zero nuclear magnetic moments, such as ¹³C, ¹⁵N, ¹²⁹Xe, ³He etc, are paramagnetic. Under ordinary circumstances, the magnetic moment of these nuclei is extremely small, much too small to be useful in producing isotopic enrichment. However, when polarized, the nuclear magnetic moment can be temporarily much larger.

For example, the dipolar field of ¹²⁹Xe, polarized to 18% and with a concentration of 1.5 M/liter has been measured to be ˜0.46 microTesla. This corresponds to a nuclear magnetization per unit volume of M/V˜78 T/m3. ¹³C has about the same gyromagnetic ratio as ¹²⁹Xe, so it follows that a similar concentration of ¹³CO₂ molecules, also polarized to ˜18%, can have a similar magnetization.

The CO₂ molecule is weakly diamagnetic, with a molecular magnetic moment per unit volume M/V˜−0.03 T/m3. This leads to the surprising insight that, for sufficient nuclear polarizations, the overall magnetic moment of an ensemble of ¹³CO₂ molecules will—temporarily—be paramagnetic as the paramagnetic nuclear magnetic moment of the ¹³C nuclei exceeds the diamagnetic magnetic moment of the CO₂ molecule itself. If the feedstock CO₂ is in the gaseous or liquid state, ¹³CO₂ molecules (i.e., those CO₂ molecules whose carbon atom is ¹³C) will therefore be attracted towards field center of a magnet whose vector magnetic field is in the same direction as that of the ¹³C nuclear polarization. ¹²CO₂ molecules will remain weakly diamagnetic as the ¹²C nucleus has a zero magnetic moment and will therefore be weakly repelled from the same field. Thus, in liquid or gaseous CO₂, separation of molecules containing ¹³CO₂ and ¹²CO₂ may be achieved by using a magnet to drive polarized ¹³CO₂ molecules in the opposite direction than unpolarized ¹²CO₂ molecules.

In a preferred embodiment, isotopic separation is carried out in liquid CO₂. This is because the relaxation rate of the nuclear polarization is much faster in gas than in liquid CO₂. Relaxation rates in liquid CO₂ have been observed to be ˜20 seconds, but much less than one second in gaseous CO₂.

In a preferred embodiment, ¹³CO₂ molecules, being ˜1.1% of solid CO₂—available in bulk as dry ice—are hyperpolarized. by exposing them to a temperature T and a magnetic field B such that the ¹³C nuclear polarization is much larger than equilibrium. In a preferred embodiment, T is less than 4 Kelvin and B is greater than 10 Tesla. To hasten polarization under conditions of high B/T, the dry ice can be milled to be in a powder form where the average particulate size is <5 microns in diameter. Optionally, various adulterants may be added to the frozen CO₂ powder; these include but are not limited to radicals, paramagnetic nanoparticles, frozen oxygen and other materials known to hasten polarization in a high B/T environment. In an additional embodiment, a Quantum Relaxation Switch (QRS) consisting of ³He and optionally ⁴He can be used; the process for using QRS to hyperpolarize gasses in a “brute force” high B/T environment is described in U.S. Pat. No. 6,651,459.

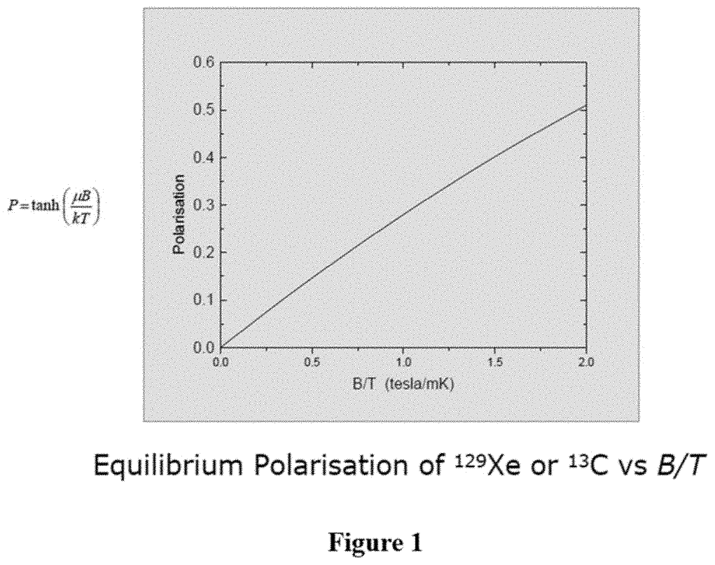

As can be seen in FIG. 1 (brute force (high B/T) polarization of ¹³C), exposing ¹³CO₂ to an environment of ˜15 Tesla and 150 mK will produce ˜5% polarization in the ¹³C nuclei contained in the raw feedstock CO₂ dry ice. Note that very large amounts of material can be cooled to these B/T conditions in relative short order. For example it has been shown in the art that 35 kg of copper can be cooled to 30 mK in ˜28 hours starting from room temperature. Assuming an additional 20 hours to polarize the ¹³CO₂, this amounts to 35 kg of raw feed every 48 hours, or ˜0.35 kg of ¹³CO₂ every 48 hours. These production rates can potentially meet or exceed current ¹³CO separation processes via fractional distillation.

Other methods to polarize molecules containing ¹³C are known in the art. These include dynamic nuclear polarization (DNP), low field thermal mixing (LFTM), Paharahydrogen Induced Polarization (PHIP). It will be understood that this list is not exhaustive and that the isotopic enrichment method described herein can be used with any combination of hyperpolarization methods.

Once the ¹³C nuclei are well polarized, a process which can be optionally monitored via NMR, the feedstock dry ice powder is warmed quickly to ˜215 K under ˜5 bar of external gas pressure. The external gas pressure can be provided, for example, by maintaining a pressure of nitrogen gas (or an inert gas or substantially unreactive gas) over the dry ice powder. Under such conditions CO₂ transitions directly from the frozen solid into the liquid state without ever becoming a gas. In a preferred embodiment, this is done in the presence of a large magnetic field, preferably in excess of 1 Tesla, even more preferably in excess of 10 Tesla. The relaxation rate of the ¹³C nuclear polarization in liquid CO₂ is ˜20 seconds in a 1 Tesla field. This is more than enough time to melt the powderized CO₂ and carry out isotopic separation described below. The magnetic field can be, for example, anywhere between about one Tesla and about 30 Tesla in increments of about 500 Gauss.

Magnetic Energy of Liquid Polarized ¹³CO₂ in a Magnetic Field B:

The process described above produces a volume containing liquid CO₂ where some percentage of the CO₂ molecules is polarized liquid ¹³CO₂. A volume of polarized liquid ¹³CO₂ in an external magnetic field B the magnetic energy per unit mole is

Eₘₒₗₑ˜μ₀(Mᵥₒₗ)B/β

Where μ₀ is the permeability constant, B the size of the external magnetic field in Tesla and ρ is the molar density of liquid CO₂. Eₘₒₗₑ will vary linearly with ¹³C polarization and magnetic field B; as an example Eₘₒₗₑ is ˜638 Joules/mole for a ¹³C polarization of 5% and a magnetic field of 10 Tesla.

Entropy of Mixing Per Unit Mole:

As noted above, CO₂ is a liquid at T˜220 K and ambient pressure of 5 bar. In feedstock liquid CO₂, the ¹³CO₂ molecules and ¹²CO₂ molecules can be expected to be completely intermixed. In order to separate liquid ¹³CO₂ from liquid ¹²CO₂ the entropy of mixing must be overcome.

Assume the process begins with a container of liquid CO₂ that fills a volume Vi. To temporarily constrain polarized liquid ¹³CO₂ to only a portion of that container Vf decreases the entropy of the ¹³CO₂ molecules.

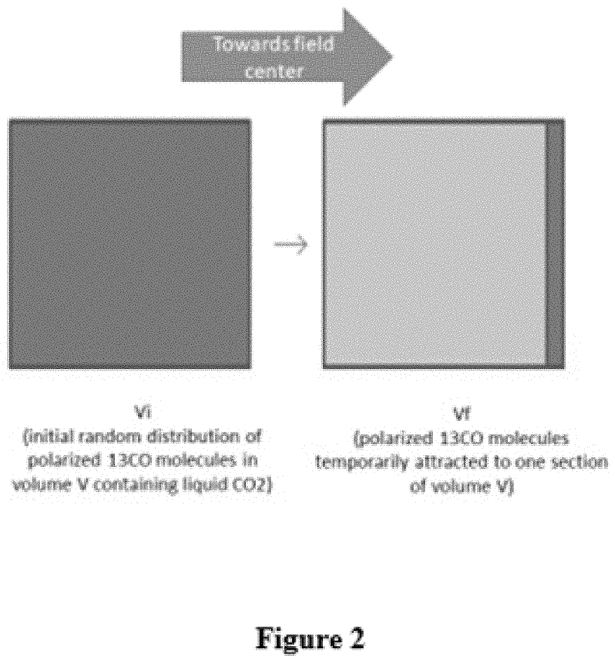

Sₘₒₗₑ=RT ln(V_{f}/Vᵢ)

Where R is Boltzmann's constant, T is the ambient temperature and Vf, Vi are the final and initial volumes of the liquid ¹³CO₂, respectively (FIG. 2).

The entropy of mixing must be overcome to effect isotopic separation. It is clear from the above that this can be done given some combination of a) sufficiently polarized ¹³CO₂ and b) large enough magnetic field. As a non exhaustive example, the ¹³C polarization is ˜5% and the magnetic field is ˜10 Tesla. In this case the average magnetic energy per mole in a 10 T magnet for the ¹³CO₂ molecules is ˜638 J/mole. Thus the minimum Vf/Vi ratio achievable in LCO₂ at 220 K is ˜0.7. In this scenario the separation constant of the new approach ˜1.3 and may require ˜17 separation stages and 1,500 moles of raw feedstock to produce 1 mole of 99% enriched ¹³CO₂. This separation constant in this non exclusive example is much improved compared to FD of CO which is ˜1.012 at T˜70 K and requires 11,400 moles of feedstock CO to produce 1 mole of 99% enriched ¹³CO.

The separation constant depends on the ¹³C polarization. As noted above polarization is not constant, but will decay with a time constant T1. It is important therefore that separation take place as quickly as possible. The rate of separation can be hastened by the use of a large magnetic field gradient over the liquid CO₂ containing some percentage of liquid, polarized ¹³CO₂ molecules. The attractive magnetic force on a ¹³CO₂ molecule will be

F/V=(1/μ₀)*(M)*ΔB

where ΔB is the local magnetic field gradient. ¹²CO₂ molecules are weakly repelled by the same local field gradient.

Preferably, the optional field gradient is ˜10 T/meter, even more preferably ˜200 T/m. For example, the field gradient can be between about 1 T/meter and about 500 T/meter, or in any increment therebetween of about 1 T/m, or any subrange between said endpoints of about 1 and about 500 T/m that is between about 1 T/m and about SOT/M in magnitude. Such a gradient can be produced for example near the outer edge of a commercially available 20 Tesla superconducting solenoid. In an alternate embodiment, very large local magnetic field gradients can be produced using a combination of steel mesh and an ambient magnetic field. Local field gradients produced by a metallic mesh, such as a magnetized steel mesh are known to be extremely large, on the order of hundreds of T/m. The ¹³CO₂ molecules are attracted into the steel mesh where they can then be separately collected.

If a solenoid is used to produce the field gradient, the gradient can optionally be pulsed in time. For example, the gradient can vary from zero to a desired level as set forth in the preceding paragraph, or can vary between a base level and a peak level. For example, the value of the gradient can vary between 0 and 500 T/m, or any subrange therein of about 10, 20, 30, 40, 50, 60, 70, 80, 90, 100, 125, 150, 175, 200, or more T/m. The pulses of the gradient can have a peak to peak time, for example, between 1.0 microseconds to about one minute, or any value therein in increments of one microsecond.

Once some degree of separation between ¹³CO₂ and ¹²CO₂ molecules has been achieved—that is, a region of space containing an enriched concentration of ¹³CO₂ has been established—a variety of methods can then be used to harvest isotopically rich ¹³CO₂ molecules from the feedstock CO₂ liquid. For example, the liquid at the top and bottom of the volume in FIG. 1 can be drained or pumped away, with the portion of liquid containing a relatively rich concentration of ¹³CO₂ being directed to a separate container. In a preferred embodiment, the liquid CO₂ is resolidified once a region of relatively rich concentration of ¹³CO₂ has been established. This can be achieved by recooling the container to a temperature <200 K, increasing the pressure head above the container, or both. The frozen CO₂ can then be sublimated directly to gas by reducing the pressure head. If heat is applied at the top of the container the gas that comes off the frozen CO₂ first will be relatively poor in ¹³CO₂; this gas is directed to one container. Subsequently the region containing relatively rich ¹³CO₂ can be sublimated with that gas directed to a second container. Any of these “harvesting” steps can be repeated as many times as necessary to achieve a desired level of isotopic purity.

The above process is described for producing enriched ¹³CO₂ molecules, which can be used as raw stock to produce a variety of ¹³C enriched molecules. Similar embodiments can be envisioned for other carbon bearing molecules such as carbon monoxide (CO), methane (CH₄) or other elements with isotopes that differ in their nuclear magnetic moments including, but not limited to: xenon, nitrogen, helium, and others.

The methods and systems of the present disclosure, as described above and shown in the drawings, provide for isotopic enrichment of various elements/molecules with superior production rates to present techniques. It will be apparent to those skilled in the art that various modifications and variations can be made in the devices and methods of the present disclosure without departing from the spirit or scope of the disclosure. Thus, it is intended that the present disclosure include modifications and variations that are within the scope of the subject disclosure and equivalents.

What is claimed is:

1) A method of separating isotopes of an element, said element having at least two isotopic forms, the method comprising:
hyperpolarizing one or more of said isotopic forms in a feedstock; and
applying a magnetic field to the target isotopes in order to at least partially spatially separate the isotopic forms of the element from one another.

2) The method of claim 1, where hyperpolarization is produced by cooling the isotopic forms in the presence of a magnetic field.

3) The method of claim 2, where the isotopic forms are cooled to at or below about 10 K in temperature and the magnetic field is at or above about 1 Tesla.

4) The method of claim 3, where an adulterant is added to the frozen element to hasten T1 in a brute force environment.

5) The method of claim 3, where a “quantum relaxation switch” is used to hasten hyperpolarization of target isotope.

6) The method of claim 1, where at least one isotope of said element has a non-zero nuclear spin.

7) The method of claim 1, wherein said element is carbon.

8) The method of claim 7, wherein said element is carbon in the form of carbon dioxide.

9) The method of claim 7, wherein said element is carbon in the form of carbon monoxide.

10) The method of claim 7, wherein said element is carbon in the form of methane

11) The method of claim 1, wherein said spatial separation of isotopic forms takes place in a liquid state.

12) The method of claim 1, wherein said spatial separation of isotopic forms takes place in a gaseous state.

13) The method of claim 1, wherein said spatial separation of isotopic forms takes place in a boundary between the liquid and gaseous states.

14) The method of claim 1, wherein a magnetic field gradient is used to facilitate the separation step.

15) The method of claim 14, wherein the magnetic field gradient is pulsed in time.

16) The method of claim 1, wherein the percentage of ¹³CO₂ in the feedstock CO₂ is <1%.

17) The method of claim 1, wherein the percentage of ¹³CO₂ in the feedstock CO₂ is <10%.

18) The method of claim 1, wherein the percentage of ¹³CO₂ in the feedstock CO₂ is <50%.

19) The method of claim 1, wherein the percentage of ¹³CO₂ in the feedstock CO₂ is <100%.

20) The method of claim 1, wherein differing nuclear polarization levels in an ensemble of more than one target isotope are produced by waiting a specified period of time for the nuclear polarization of one isotope to decay away to a smaller value than that of the other isotope or isotopes.
